(19) United States
(12) Patent Application Publication
(10) Pub. No.: US 2007/0115254 A1
(43) Pub. Date: May 24, 2007

(54) Apparatus, computer device, method and computer program product for synchronously controlling a cursor and an optical pointer

(76) Inventor: Cheng-Han Wu, Taipei County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/372,002

(22) Filed: Mar. 9, 2006

(30) Foreign Application Priority Data
Nov. 23, 2005 (TW) 094141146

(51) Int. Cl. G09G 5/00

(52) U.S. Cl. 345/156

(57) ABSTRACT

An apparatus, computer device, method and computer program product for synchronously controlling a cursor and an optical pointer are provided. The method comprises the steps of generating an optical point on a screen using an optical pointer, capturing the image of the screen and generating an image signal according to the image by an image capture device, analyzing the image signal by a cursor position calculation device and repositioning a new position of a cursor on a computer screen.

### CROSS-REFERENCES TO RELATED APPLICATIONS

This application claims priority to Taiwan Patent Application No. 094141146 filed on Nov. 23, 2005.

STATEMENT REGARDING FEDERALLY SPONSORED RESEARCH OR DEVELOPMENT

Not applicable

### BACKGROUND OF THE INVENTION

1. Field Of The Invention

The invention relates to a handheld pointer controlling device, a computer device, a method, and a computer program product thereof that use the handheld pointer controlling device to control a cursor; specifically to a handheld pointer controlling device, a computer device, a method and a computer program product thereof that make a cursor follow optical projection.

2. Descriptions Of The Related Art

When computers are used extensively in graphical presentation systems, large scale display equipments are required for attendants' convenience. For example, projection equipments with large scale project screens are utilized widely in presentation systems of large conventions. Not only do these techniques need to have well communication interfaces between presentation systems and computer devices, but they also have to be easily operated so that speakers can easily manage communications with audiences.

Traditionally, speakers often use batons or pointers to guide audiences about information on the project screens. Using a pointer as an example, a pointer is an indicator that emits light, such as a laser pointer. A laser pointer generates a laser point on the project screen so that the speaker can make audiences concentrate around that spot. However, traditional pointers only have optical indicating ability, so speakers often need extra computer peripheral accessories such as computer mouse in order to operate computers for showing different presentation content. Speakers have to operate computers and guide presentation content at the same time, which degrades the fluency of presentations.

Consequently, a better presentation equipment that integrates a pointer with a computer mouse is an improvement compared with the above-mentioned; particularly, the integration of the aforementioned pointer with a wireless computer mouse to make the wireless computer mouse have the functionalities of both a laser pointer and a computer mouse. However, as shown in FIG. 1, a laser pointer A and a computer mouse cursor B cannot be operated synchronously, though they are integrated into one unit. Thus, when speakers need to operate the computer, he or she needs to switch to the computer mouse mode, and then move the cursor to the intended position to operate the computer. Therefore, this technique cannot be utilized to operate directly by means of the position indicated by a laser pointer.

In U.S. Pat. No. 6,331,848 B1, the technique is a new project presentation system. It utilizes an independent camera to capture a brightest point on a project screen and to make it as the image signal of the laser pointer. After analyzing by a computer, the relative position of the laser pointer on the project screen is derived and then is provided to a computer cursor for further computer operations. Although the technique disclosed in this patent solves the aforementioned problem of synchronization between a laser pointer and a computer mouse cursor, the calculation of the position of the light position and the signal processing system are more complicated. Meantime, using the brightest point on the project screen as the indicator of a laser pointer is usually affected by the brightness of presentation data, which further determines an error position of light point and reduces the fluency and accuracy of computer operations. Besides, the camera used to capture the laser pointer of this invention is an independent equipment, which limits a speaker to perform presentations at specific locations and this is very inconvenient for presentations.

Consequently, it is essential to develop a new system and a new method that integrate a computer mouse cursor and an optical project pointer accurately and efficiently so that operations of presentation systems are convenient, fluent, and humanized.

### SUMMARY OF THE INVENTION

An object of this invention is to provide a handheld computer cursor controlling device for controlling a cursor of a computer device, which shown on a display. The handheld computer cursor controlling device comprises an optical pointer, an image capturing device, and a signal transmission device. The optical pointer is used for generating an optical projection on the display. The image capturing device is used for capturing an image from a captured area on the display and generating an image signal, and the signal transmission device is used for transmitting the image signal to the computer device, wherein the computer device reposition the cursor according to the image signal.

Another object of this invention is to provide a computer device, which controls a cursor by a handheld computer cursor controlling device. The cursor is shown on a display. The handheld computer cursor controlling device generates an optical projection on the display, captures an image from a captured area on the display, and generates an image signal. The image signal comprises a first coordinate within the captured area and the coordinates of the four corners of the image. The computer device comprises a curser position calculation device for repositioning the cursor according to the image signal.

Another object of this invention is to provide a method for controlling a cursor of a computer device by a handheld computer cursor controlling device. The cursor is shown on the display. The method comprises the following steps of: (a) generating an optical projection on the display by the handheld computer cursor controlling device; (b) capturing an image from a captured area on the display by the handheld computer cursor controlling device; (c) generating an image signal according to the image by the handheld computer cursor controlling device; and (d) repositioning the cursor according to the image signal by the computer device.

Yet another objection of this invention is to provide a computer program product for storing a computer program to execute a method for controlling a cursor of a computer device by a handheld computer cursor controlling device. The handheld computer cursor controlling device generates an optical projection and the cursor is shown on a display. The method comprises the following steps of: (a) controlling the handheld computer cursor controlling device to capture an image from a captured area on the display; (b) generating an image signal according to the image; and (c) repositioning the cursor according to the image signal.

### BRIEF DESCRIPTION OF THE DRAWINGS

FIG. 1 is a diagram of prior presentation projection display system;

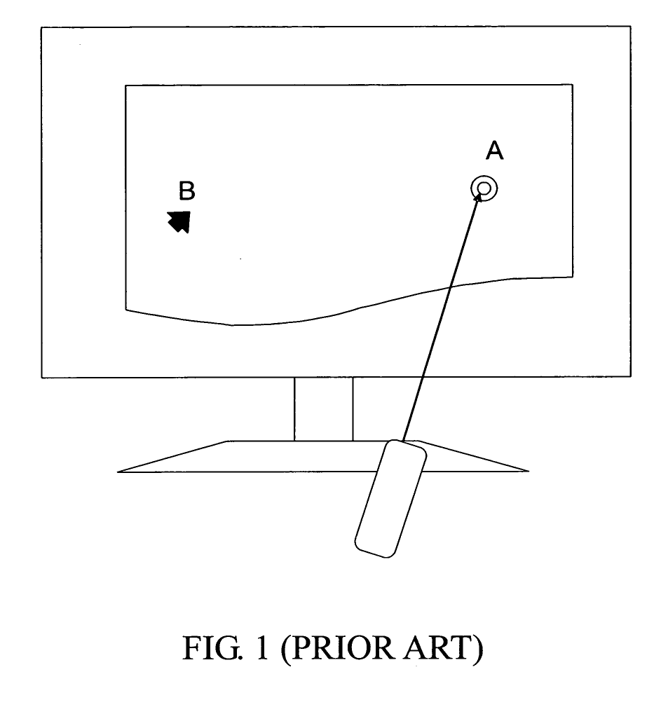

FIG. 2 is an embodiment of applying this invention to a computer projection display system;

FIG. 3 is an embodiment of applying this invention to a computer projection display system;;

FIG. 4 is a diagram showing an included angle between a speaker and the projection display;

FIG. 5 is an embodiment of applying this invention to a computer projection display system under the condition illustrated in FIG. 4; and

FIG. 6 is a flow chart of applying this invention to control a cursor of a computer device.

### DESCRIPTION OF THE PREFERRED EMBODIMENT

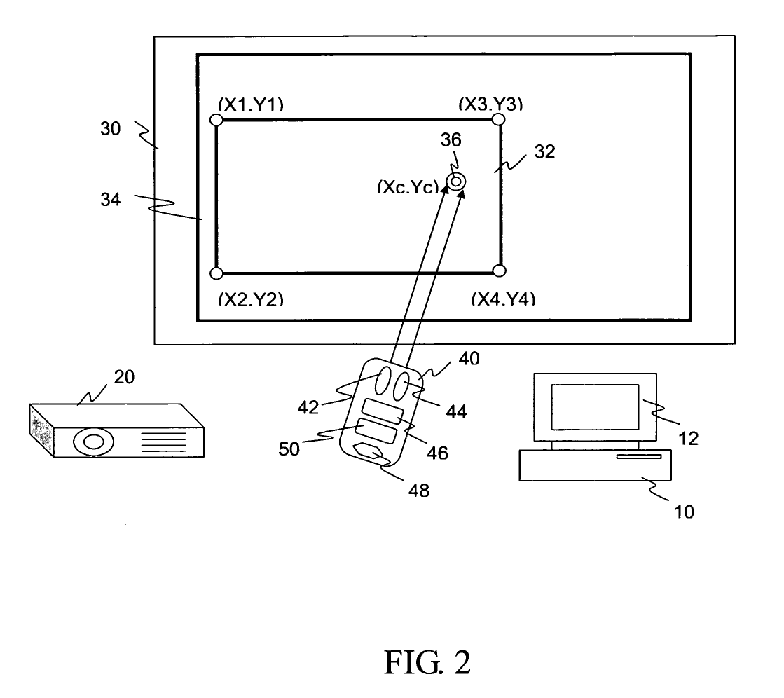

FIG. 2 shows an embodiment of applying this invention to a computer projection display system. The computer projection display system comprises a computer device 10, a projection device 20, a display 30, and a handheld computer cursor controlling device 40. A speaker can use the computer device 10 to operate the presentation content so that a projected image of the presentation content is generated on a display 30 through the projection device 20.

To be more specifically, the computer device 10 further comprises a computer screen 12. The presentation content stored in the computer device 10 can be shown on a computer screen 12 and can also be shown as a projected image on a projected area 32 within a display 30 through the project device 20. It is worth to mention that any display device that can present images can be used in this invention, such as projection screen, digital television screen, etc. A projection screen is adopted in our embodiment in the following.

In addition, the computer cursor controlling device 40 that utilizes this disclosed invention is a handheld device because of the portability and convenience for users. The handheld computer cursor controlling device 40 comprises an optical pointer 42, an image capturing device 44, a cursor controlling unit 46, a signal transmission device 48, and a cursor position calculation device 50.

To be more specifically, the optical pointer 42 can generate an optical projection 36 on the projection screen 30 so that a speaker can easily indicate the important part of the presentation content to the audience during the presentation. The optical pointer 42 can be a laser pointer, for example, which can generate a laser point on the projection screen. This invention differs from prior art in that the handheld computer cursor controlling device 40 in this invention comprises an image capturing device 44. The image capturing device 44 can be a charge coupled device (CCD) or a complementary metal-oxide semiconductor (CMOS). The main function of the image capturing device 44 is to capture an image generated by the projection device 20 from the projection screen 30 and to generate a corresponding image signal. In detail, the image capturing device can capture an image from a captured area 34 within the projection screen 30 in order to generate an image signal. The image signal captured by this invention comprises the following information: first, the coordinate of the center (Xc, Yc) of the captured area 34; and second, the coordinates of the four corners (X1, Y1), (X2, Y2), (X3, Y3), and (X4, Y4) of the projected area 32. In practical application, the light intensities of the four corners can be increased or some special recognition method can be used in order to essentially raise the recognition rate of the four corners.

For a preferred embodiment, the distance between the optical pointer 42 and the image capturing device 44 should not be too long, e.g. no longer than 10 cm. There are two reasons to decide the disposition therebetween. First, if the distance between the two devices is too long, the size of the handheld computer cursor controlling device will be too large, which is inconvenient to speakers for use. Second, the optical pointer 42 and the image capturing device 44 should be equipped in a way that the optical path of the laser point of the optical pointer 42 and that of the image capturing device 44 to capture images should be substantially close and be in parallel to each other. Thus, speakers can synchronously operate the laser point 36 and the computer mouse cursor. To be more specifically, the laser point on the projection screen 30 by the optical pointer 42 and the center point of the captured area 34 where the image capturing device 44 intends to capture images are substantially superimposed as one point.

Moreover, the functionality of the cursor controlling unit 46 is the same as that of a computer peripheral. That is, it is able to move a computer mouse cursor (not shown) and is also able to generate a controlling signal for the computer device 10 to execute a function corresponding to the cursor, which provides users to operate the computer device 10. It is necessary to mention that the computer mouse cursor generated on the computer screen 12 has a corresponding image of the computer mouse cursor on the projected area 32 within the project screen 30 via the project device 20. Operators can achieve the same effect of operating the computer mouse cursor on the computer screen 12 by operating the image of the computer mouse cursor on the projected area 32.

Furthermore, the main function of the signal transmission device 48 is to transmit signals between the computer device 10 and the handheld computer cursor controlling device 40. In this embodiment, the signal transmission device 48 is responsible for transmitting pointer controlling signal generated by the cursor controlling unit 46 to the computer device 10 so that the speaker can operate the computer device 10 in order to proceed the presentation. In concrete, the signal transmission device can be a wireless signal transmission device or a wired signal transmission device. Besides, the curser position calculation device 50 is used to analyze the image signal generated by the image capturing device 44. After operation, the computer mouse cursor follows the movement of the laser point 36, so users can operate the computer mouse cursor and the laser point 36 on the projection screen 30 synchronously or operate the single computer cursor directly.

In prior art, the computer mouse cursor and the laser point, generated by the optical pointer 42, on the projected area 32 are operated independently. This makes the pointer to the presentation content and the control of computer operation have to be operated separately by the speaker, which is very inconvenient. This invention differs from the prior art in that the disclosed technique in this invention can facilitate the speaker to operate the laser point 36 and the computer mouse cursor synchronously and easily, so the process of the presentation and the operation of the computer can be proceeded synchronously. The principle of the application is described in the following paragraphs.

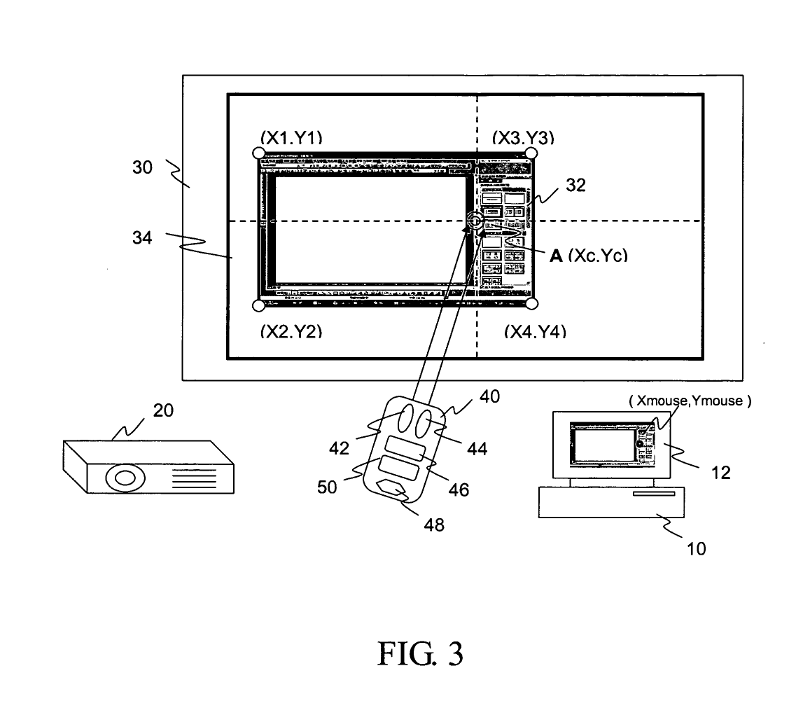

Consider an example that the optical path for the image capturing device 44 to capture an image and the plane of the projection screen 30 is orthogonal as shown in FIG. 3. First, when a speaker starts a presentation system, the presentation content on the computer screen 12 can be shown as an image on a projected area 32 within the projection screen 30 by the project device 20. Second, during the presentation, if the speaker intends to show audiences about information at some specific position within the projected area 32, the speaker can use the optical pointer 42 of the handheld computer cursor controlling device 40 to emit a laser, so a laser point will be formed at the position. If the speaker intends to control the presentation content such as scrolling the presentation content, the speaker has to move the handheld computer cursor controlling device 40 first, and then move the laser point, generated on the projected area 32 by the optical pointer 42, to the control point A, which acts as a scroll for scrolling the presentation content, up or down, within the projected area 32. After that, starts the image capturing device 44 of the handheld computer cursor controlling device 40 to capture the image including, for example, the coordinates of the four corners of the projected area (X1, Y1), (X2, Y2), (X3, Y3), (X4, Y4) and the coordinate of the center of the captured area 34 (Xc, Yc). By utilizing the image signal, the curser position calculation device 50 is able to calculate a new coordinate of a computer mouse cursor on the computer screen corresponding to the relation between the point A and the projection screen 30. Sequentially, the coordinate of the computer mouse cursor on the computer screen could be reset and enable the speaker to scroll the presentation content on the projection screen 30 directly by means of the laser point 36 thereof.

To be more specifically, in the preferred embodiment of this invention, the controller for starting the image capturing device and the controller of the optical pointer can be integrated as one control button so that the control button has a two-stage functionality. For example, if pressing the first-stage process of the control button is to start the optical pointer for generating a laser point, then pressing the second-stage process of the control button successively to start the image capturing device to capture image information for further calculation.

To emphasize again, the center of the captured area 34 formed by the image capturing device 44 on the projection screen 30 is also located at point A, that is, the coordinate of A is (Xc, Yc). In practice, the image capturing device 44 will transmit the image signal, including the coordinates of the four corners and the coordinate of the center, to the curser position calculation device 50. Consequently, the disclosed technique in this invention does not have to determine the brightest point on the projection screen in order to reposition the coordinate of the computer mouse like the prior art does. On the other hand, the disclosed technique of this invention uses the position of the center and the four coordinates of the captured area instead, so it overcomes the difficulties of determining the brightest point and the error generated consequently of the prior art. From the aforementioned description, the first relation equations built in the curser position calculation device 50 are calculated by:
Xmouse=Xscreen×(Xc−X1)/(X4−X1)
Ymouse=Yscreen×(Yc−Y1)/(Y4−Y1)

wherein Xmouse represents the new horizontal coordinate of the computer mouse cursor on the computer screen, Ymouse represents the new vertical coordinate of the computer mouse cursor on the computer screen, Xscreen indicates the width of the computer screen, Yscreen indicates the length of the computer screen, and Xscreen and Yscreen are known.

To elaborate, the above equations are derived based on the projected image on the projection screen which is projected from the image on the computer screen. Cosequently, there exists a proportion between the two. Calculating the relation of the coordinate of the laser point on the coordinate system of the projected area will derive the corresponding position of the coordinate of the laser point on the computer screen. In addition, the corresponding position is repositioned to be the new coordinate of the computer mouse cursor on the computer screen.

In other words, the relations between the center of the captured area 34 (Xc, Yc) and the four corners of the projected area 32 are set to be the relations between the new position of the computer mouse cursor on the computer screen and the coordinate system of the computer screen. Use the aforementioned information, the curser position calculation device 50 can derive coordinate (Xmouse, Ymouse) as the new coordinate of the computer mouse cursor on the computer screen. The new coordinate is further transmitted to the computer 10 through the signal transmission device 48, so the computer 10 changes the original position of the computer mouse cursor on the computer screen to (Xmouse, Ymouse). By repositioning the position of the computer mouse cursor on the computer screen, the object of synchronously operating computer mouse cursor and laser point can be achieved. Even more, the computer mouse cursor and the optical projection are integrated as one computer pointer, so users can synchronously control the computer mouse cursor by controlling the optical pointer projection.

In simplification, everytime an operator needs to control optical projection and computer mouse cursor. If the handheld computer cursor controlling device disclosed in this invention is adopted, the position of the computer mouse cursor can be repositioned easily by the aforementioned process so that the two pointers can be easily operated simultanesously by the operator. Disvantages of complicated operation in prior arts are overcomed by this invention.

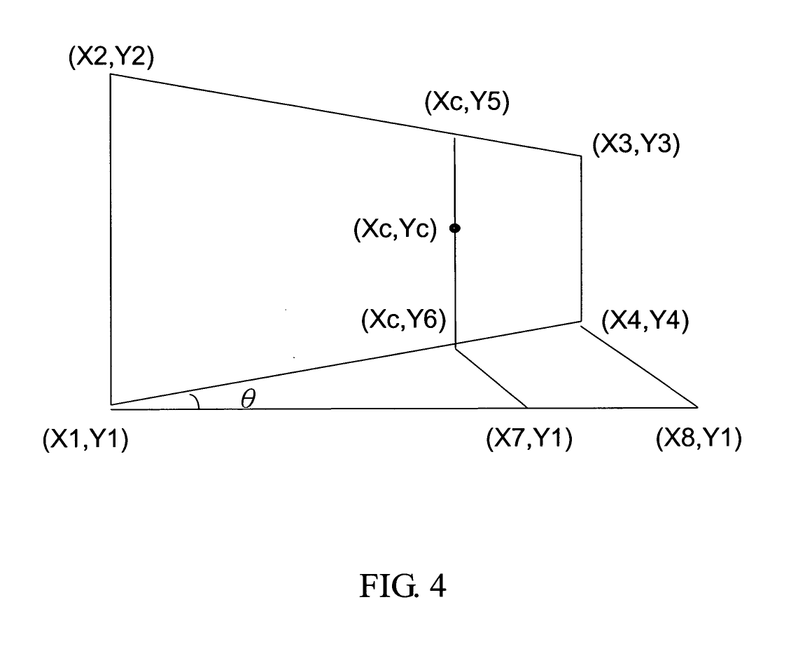

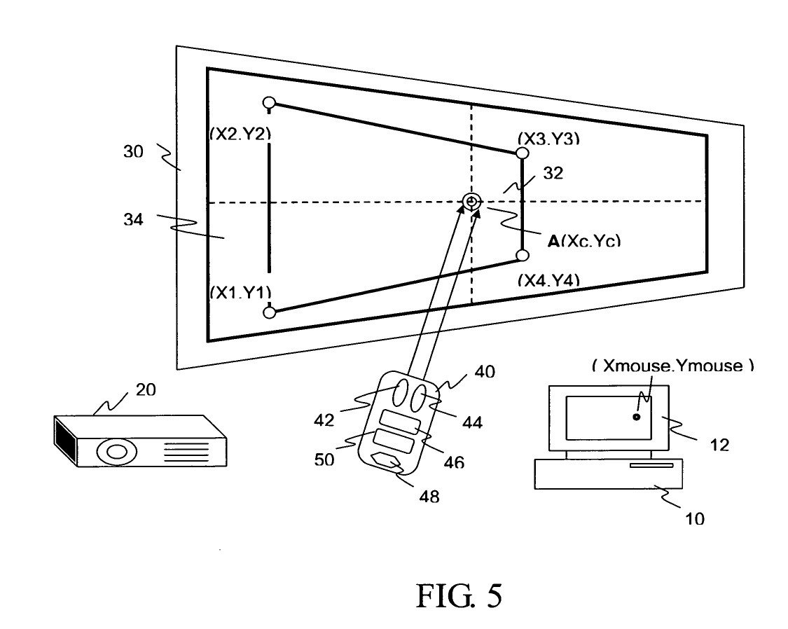

Furthermore, according to the above-mentioned, the optical path for the image capturing device to capture images and the normal of the projection screen are approximately in parallel. Particularly, the curser position calculation device comprises an angle correction equation (a second relation equation). It means that if there is an angle between the optical path and the normal of projection screen, adequate modification can be made to the aforementioned relation equation. This feature of the handheld computer cursor controlling device of this invention is more similar to the real situation that a speaker moves around during the presentation as shown in FIG. 4 and FIG. 5. The details are elaborated in the following paragraphs.

Assume the projection screen uses X-axis as the horizontal axis, Y-axis as the vertical axis, and Z-axis as the perpendicular axis to the surface formed by X- and Y-axes as shown in FIG. 4. In the figure, the optical path to capture images and the projection surface form an included angle θ against the Z-axis. That is, the included angle between the speaker and the Z-axis of the projection surface has an included angle θ. By using the optical Lagrange-Helmholtz Theorem, the angle deviation of X- and Y-axes along Z-axis during image capturing can be calculated. By using the angle deviation, the corresponding position of (Xc, Yc) on the computer screen can be derived. According to the Lagrange-Helmholtz Theorem: ynu=y′n′u′

wherein y is a length, u is an angle, and n is a refractive index (the refractive index of air is 1).

Thus, the above equation can be rewritten as yu=y′u′
u′=y/y′×u
rotation angle θ=u−u′=(1−y/y′)×u

If the paraxial angle u=1,

then we can derive θ=1−y/y′.

It is necessary to mention that the rotation angle of Y-axis depends on the location of the speaker. As shown in FIG. 4, the farther side of the surface shrinks. Next, the new coordinate of the computer mouse cursor is derived by the following relation equations.
Y5=Y2−(Y2−Y3)×(X2−Xc)/(X2−X3)
Y6=Y1+(Y4−Y1)×(X1−Xc)/(X1−X4)
Ymouse=Yscreen×(Yc−Y6)/(Y5−Y6)

Apply Y5 and Y6 to the above equation to get the value of Ymouse.

Next,
X7=Xc/Cosθ
X8=X4/Cosθ

Apply the value ofθ derived by the Lagrange-Helmholtz Theorm, X7 and X8 can be derived. Then, apply X7 and X8 to the following equation to derive Xmouse.
Xmouse=Xscreenx(X7−X1)/(X8−X1)

According to the aforementioned angle correction equations, the curser position calculation device 50 can derive the new coordinate (Xmouse, Ymouse) of the angle-corrected computer mouse cursor.

The aforementioned description is only one of the embodiments of this invention. People skilled in the art can easily deduce an embodiment according to the disclosed technique in this invention. For example, the curser position calculation device 50 of the handheld computer cursor controlling device can be equipped on the computer system so that the handheld computer cursor controlling device only comprises an optical pointer, an image capturing device, a cursor controlling unit, and a signal transmission device, which is also another embodiment of this invention. It is necessary to explain that the signal transmitted to the computer by the signal transmission device here is different from that in the previous embodiment. The transmitted signal here is not the pointer controlling signal generated by the cursor position calculation device but the original image signal, captured by the image capturing device. The signal comprises the coordinate of the center of the captured area (Xc, Yc) and the coordinates of the four corners the projection area (X1, Y1), (X2, Y2), (X3, Y3), and (X4, Y4).

Actually, there are still other embodiments of this invention. For example, the display can be a digital television. To be more specifically, a handheld computer cursor controlling device of this invention can be integrated with a television remote control. In this way, users can use an optical pointer emitted from television remote control to control computer devices within the digital home television directly. The control of the functionalities of the digital home television is achieved without using television remote control and computer mouse separately.

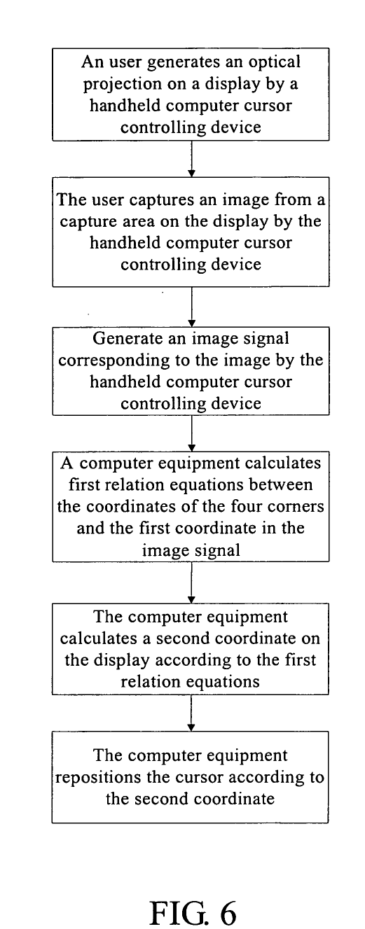

From the above description, this invention also provides a method to control a mouse cursor of a computer device by a handheld computer cursor controlling device as shown in FIG. 6. The computer mouse cursor is shown on a display, which comprises the following steps.

(a) Generate an optical projection on the display by the handheld computer cursor controlling device.

(b) Capture an image from a captured area within the dispaly by the handheld compute pointer controlling device.

(c) Generate an image signal according to the image by the handheld computer cursor controlling device.

(d) The computer reposition the cursor according to the image signal.

The image signal comprises a first coordinate within the captured area and the four coordinates of the image. The first coordinate can be the center of the captured area. The step

(d) further comprises the following steps.

(e) Calculate a first relation equations between the first coordinate and the four coordinates.

(f) Calculate a second coordinate on the display according to the first relation equations.

(g) Reposition the cursor according the the second coordinate.

The method may be executed by using a computer program product which stores a computer program. The computer program comprises code to execute the above-mentioned steps of the method. The computer program product can be a floppy disk, a hard disk, an optical disc, a flash disk, a tape, an internet accessible database or any storage medium with a similar functionality of storage which is easily thought by people skilled in the art.

To sum up, this invention is a handheld computer cursor controlling device integrating laser projection device and image capturing device. When users use the laser pointer, the point indicated by the pointer superimposes the computer mouse cursor. Users can operate the computer directly without switching back to the computer mouse. Specially, this invention is a handheld device and may be used in any place. It is also convenient for users to carry and can increase the fluency of presentations.

The above embodiments are used as the examples of the subject invention and disclosed to explain the technical characters of the subject invention and are not used to limit the range of the claimed subject matter. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A handheld computer cursor controlling device for controlling a cursor of a computer device, the cursor being shown on a display, the handheld computer cursor controlling device comprising:
an optical pointer for generating an optical projection on the display;
an image capturing device for capturing an image from a captured area on the display and generating an image signal; and
a signal transmission device for transmitting the image signal to the computer device, wherein the computer device reposition the cursor according to the image signal.

2. The handheld computer cursor controlling device of claim 1, wherein the distance between the optical pointer and the image capturing device is not longer than 10 cm.

3. The handheld computer cursor controlling device of claim 1, wherein the optical pointer is a laser pointer.

4. The handheld computer cursor controlling device of claim 1, wherein the image capturing device is a charge coupled device (CCD).

5. The handheld computer cursor controlling device of claim 1, wherein the signal transmission device is a wireless signal transmission device.

6. The handheld computer cursor controlling device of claim 1, wherein the image signal comprises a first coordinate within the captured area.

7. The handheld computer cursor controlling device of claim 1, wherein the image signal comprises the coordinates of the four corners of the projected area.

8. The handheld computer cursor controlling device of claim 1, further comprising a cursor controlling unit for operating the computer device.

9. A computer device, controlling a cursor by a handheld computer cursor controlling device, the cursor being shown on a display, the handheld computer cursor controlling device generating an optical projection on the display, capturing an image from a captured area on the display, generating an image signal, the image signal comprising a first coordinate within the captured area and the coordinates of the four corners of the image, the computer device comprising an curser position calculation device for repositioning the cursor according to the image signal.

10. The computer device of claim 9, wherein the first coordinate is the coordinate of the center of the captured area.

11. The computer device of claim 9, the curser position calculation device makes the cursor follow the optical projection by a method comprising the following steps of:
calculating a first relation equation between the coordinates of the four corners and the first coordinate;
calculating a second coordinate of the display according to the first relation equation; and
repositioning the cursor according to the second coordinate.

12. A method for controlling a cursor of a computer device by a handheld computer cursor controlling device, the pointer being shown on the display, the method comprising the following steps of:
(a) generating an optical projection on the display by the handheld computer cursor controlling device;
(b) capturing an image from a captured area on the display by the handheld computer cursor controlling device;
(c) generating an image signal according to the image by the handheld computer cursor controlling device; and
(d) repositioning the cursor according to the image signal by the computer device.

13. The method of claim 12, wherein the image signal comprises a first coordinate within the captured area.

14. The method of claim 13, wherein the first coordinate is the coordinate of the center of the captured area.

15. The method of claim 13, wherein the image signal further comprises the coordinates of the four corners of the image.

16. The method of claim 15, wherein the step (d) comprises the following steps of:
(a) calculating a first relation equation between the coordinates of the four corners and the first coordinate;
(b) calculating a second coordinate of the display according to the first relation equation; and
(c) repositioning the cursor according to the second coordinate.

17. A computer program product for storing a computer program to execute a method for controlling a cursor of a computer device by a handheld computer cursor controlling device, the handheld computer cursor controlling device generating an optical projection, the cursor being shown on a display, the method comprising the following steps of:
(a) controlling the handheld computer cursor controlling device to capture an image from a captured area on the display;
(b) generating an image signal according to the image; and
(c) repositioning the cursor according to the image signal.

18. The computer program product of claim 17, wherein the image signal comprises a first coordinate within the captured area.

19. The computer program product of claim 18, wherein the first coordinate is the coordinate of the center of the captured area.

20. The computer program product of claim 18, wherein the image signal further comprises the coordinates of the four corners of the projected area.

21. The computer program product of claim 20, wherein the step (c) comprises the following steps:
(a) calculating a first relation equation between the coordinates of the four corners and the first coordinate;
(b) calculating a second coordinate of the display according to the first relation equation; and
(c) repositioning the cursor according to the second coordinate.
